(19) United States
(12) Patent Application Publication
(10) Pub. No.: US 2024/0187941 A1
(43) Pub. Date: Jun. 6, 2024

(54) METHOD AND APPARATUS FOR MANAGING CAPABILITY REPORTING OF UE IN WIRELESS COMMUNICATION SYSTEM SUPPORTING DUAL CONNECTIVITY

(71) Applicant: Samsung Electromics Co., Ltd., Gyeonggi-do (KR)

(72) Inventors: Himke VAN DER VELDE, Middlesex (GB); Seungbeom JEONG, Gyeonggi-do (KR)

(21) Appl. No.: 18/552,370

(22) PCT Filed: Mar. 23, 2022
(86) PCT No.: PCT/KR2022/004073

§ 371 Date: Sep. 25, 2023

(30) Foreign Application Priority Data
Mar. 24, 2021 (GB) 2104085.2
Mar. 17, 2022 (GB) 2203741.0

(51) Int. Cl. H04W 36/00; H04W 72/51; H04W 76/15

(52) U.S. Cl. CPC H04W 36/0069; H04W 72/51; H04W 76/15

(57) ABSTRACT

Disclosed is a method and apparatus of managing capability reporting by a UE in a wireless communication system configured for dual connectivity (DC), the method comprises receiving, from a base station, a first capability enquiry comprising information on a first set of bands, transmitting, to the base station, a first reply including information indicating that the UE supports more than a predefined number of bands, in case that the UE supports more than the predefined number of bands, receiving, from the base station, a second capability enquiry comprising information on a second set of bands more than the predefined number of bands, and transmitting, to the base station, a second reply including UE capability information associated with the second set of bands.

### TECHNICAL FIELD

The disclosure relates generally to dual connectivity (DC) in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In cases where a UE is configured with the DC in the wireless communication system, the UE is connected via a Master Cell Group (MCG) to a Master Node (MN) and a Secondary Cell Group (SCG) to a Secondary node (SN). Each node sets the parameters of the cell group it controls, but the nodes interact to ensure that UE capabilities are respected. This is needed, as what the UE may support for the SCG may depend on what is configured for the MCG. As an example, such coordination is needed to ensure that the nodes, together, configure a Band Combination, BC, in accordance with UE capabilities.

The DC may take different forms, but it typically involves a UE being simultaneously connected to at least two different nodes in the wireless communication system. Such an arrangement poses certain difficulties in terms of network configuration and planning.

### DISCLOSURE OF INVENTION

### Technical Problem

Aspects of the disclosure are to address at least the above-mentioned problems and/or disadvantages and to provide at least the advantages described below.

Accordingly, an aspect of the disclosure is to provide a method and apparatus of efficiently managing capability reporting by a UE in a wireless communication system supporting the DC.

Accordingly, another aspect of the disclosure is to provide a method and apparatus of efficient capability filtering for capability reporting by a UE in response to a capability enquiry from a base station of a wireless communication system.

### Solution to Problem

According to an aspect of the disclosure, a method of managing capability reporting by a user equipment (UE) in a wireless communication system configured for dual connectivity (DC) is provided, the method comprises receiving, from a base station, a first capability enquiry comprising information on a first set of bands, transmitting, to the base station, a first reply including information indicating that the UE supports more than a predefined number of bands, in case that the UE supports more than the predefined number of bands, receiving, from the base station, a second capability enquiry comprising information on a second set of bands more than the predefined number of bands, and transmitting, to the base station, a second reply including UE capability information associated with the second set of bands.

According to an aspect of the disclosure, a UE in a wireless communication system configured for DC is provided, the UE comprises a transceiver, and a processor configured to receive, via the transceiver the from a base station, a first capability enquiry comprising information on a first set of bands, transmit, to the base station via the transceiver, a first reply including information indicating that the UE supports more than a predefined number of bands, in case that the UE supports more than the predefined number of bands, receive, via the transceiver from the base station, a second capability enquiry comprising information on a second set of bands more than the predefined number of bands, and transmit, to the base station via the transceiver, a second reply including UE capability information associated with the second set of bands.

According to an aspect of the disclosure, a method of managing capability reporting by a base station in a wireless communication system configured for DC is provided, the method comprises transmitting, to a UE, a first capability enquiry comprising information on a first set of bands, receiving, from the UE, a first reply including information indicating that the UE supports more than a predefined number of bands, in response to transmission of the first capability enquiry, transmitting, to the UE, a second capability enquiry comprising information on a second set of bands more than the predefined number of bands, and receiving, from the UE, a second reply including UE capability information associated with the second set of bands.

According to an aspect of the disclosure, a base station in a wireless communication system configured for DC is provided, the base station comprises a transceiver, and a processor configured to transmit, to a UE, a first capability enquiry comprising information on a first set of bands, receive, from the UE, a first reply including information indicating that the UE supports more than a predefined number of bands, in response to transmission of the first capability enquiry, transmit, to the UE, a second capability enquiry comprising information on a second set of bands more than the predefined number of bands, and receive, from the UE, a second reply including UE capability information associated with the second set of bands.

According to a first aspect of the disclosure, there is provided a method of managing capability reporting by a UE in a telecommunication network configured for DC, wherein a base station of the network sends to the UE a capability enquiry comprising a first set of bands, the UE replies, with a first reply to the base station to indicate that it supports more than a predefined number of bands if it is capable of doing so and the base stations sends a further request to the UE with a second set of bands, including details of the more than the predefined number of bands and the UE replies with a second reply including the requested information.

According to a second aspect of the disclosure, there is provided a method of capability filtering for capability reporting by a UE in response to a capability enquiry from a base station of a telecommunication network, in a telecommunication network configured for DC, wherein the telecommunication network (e.g. a base station) controls cell grouping information that the UE includes in its capability report, wherein the network (e.g. a base station) controls the cell grouping information by including in its enquiry one or more of:
a) a field indicating whether the UE shall include cell grouping for asynchronous DC;
b) a field indicating whether the UE is allowed to include cell grouping for asynchronous DC other than ‘R15 grouping’ and ‘any grouping’;
c) a field indicating whether the UE shall include cell grouping for synchronous DC; and
d) a field indicating whether the UE is allowed to include cell grouping for synchronous DC other than ‘R15 grouping’ and ‘any grouping’.

According to a third aspect of the disclosure, there is provided a method of managing capability reporting by a UE in a telecommunication network configured for DC, wherein the telecommunication network (e.g. a base station) includes in a UE capability enquiry, a band list comprising more than a predefined number of band and the UE replies to the capability enquiry with one of the following messages:
a) the UE reply does not include any BCs with more than the predefined number of bands;
b) the UE reply only includes BCs with more than the predefined number of bands, for which it supports R15 grouping (MCG in FR1 and SCG in FR2);
c) the UE reply only includes BCs with more than the predefined number of bands, for which cell grouping may be indicated by R16 UE capability signalling, including:
i) BCs for which the supports R15 grouping (MCG in FR1 and SCG in FR2); and
ii) BCs for which the UE supports any cell grouping.

According to a fourth aspect of the disclosure, there is provided a method of managing capability reporting by a UE in a telecommunication network configured for Dual Connectivity, DC, wherein the UE is arranged to report its capability in RN format, supporting cell grouping, whereby the UE reports BCs using RN format for one of:
1) BCs with more than the predefined number of bands;
2) Any BC; and
3) Specific BCs, in accordance with network control.

According to a fifth aspect of the disclosure, there is provided a method of managing capability reporting by a UE in a telecommunication network configured for DC, wherein the telecommunication network (e.g. a base station) includes in a capability enquiry to the UE one of:
a) a field indicating that the UE is allowed or requested to use RN format;
b) a field indicating that the UE is allowed or requested to use RN format for BCs having more than a predefined number of bands;
c) a field indicating that the UE is allowed or requested to use RN format for BCs having the predefined number of bands or less; and
d) a field indicating that the UE is allowed or requested to use RN format for specific BCs, including an indication of a particular criterion the the BC should meet in order to use RN format.

In an embodiment, for option d), the particular criterion includes one or more of:
a) the BC comprises specific bands as indicated by the network;
b) the BC comprises at least a certain number of bands; and
c) the BC comprises bands with specific properties, such as being a part of a particular frequency range.

According to a sixth aspect of the disclosure, there is provided apparatus arranged to perform any one of the preceding aspects.

In an embodiment, the apparatus comprises at least one of a base station of a wireless communication system and a User Equipment.

Although a few preferred embodiments of the disclosure have been shown and described, it will be appreciated by those skilled in the art that various changes and modifications might be made without departing from the scope of the invention, as defined in the appended claims.

According to the disclosure there is provided an apparatus and method as set forth in the appended claims. Other features of the disclosure will be apparent from the dependent claims, and the description which follows.

For a better understanding of the invention, and to show how embodiments of the same may be carried into effect, reference will now be made, by way of example only, to the accompanying diagrammatic drawings.

### BRIEF DESCRIPTION OF DRAWINGS

The above and other aspects, features, and advantages of certain embodiments of the disclosure will be more apparent from the following detailed description taken in conjunction with the accompanying drawings, in which:

FIG. 1 shows a control plane architecture in a wireless communication system;

FIG. 2 shows a 2 step capability enquiry according to an embodiment of the disclosure; and

FIG. 3 shows a block diagram of a network entity performing operations according to an embodiment of the disclosure.

### MODE FOR THE INVENTION

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, a base station is a subject that performs resource allocation to a user equipment (UE), and may be at least one of a gNode B, a gNB, an eNode B, an eNB, a Node B, a base station (BS), a radio access unit, a base station controller, or a node on a network. The base station may be a network entity, in an NR system, including at least one of an integrated access and backhaul (IAB)-donor that is a gNB which provides network access to a UE(s) via a network of backhaul and access links and an IAB-node that is a radio access network (RAN) node which supports NR access link(s) to a UE(s) and supports NR backhaul links to the IAB-donor or other IAB-nodes. A UE may be wirelessly connected via an IAB-node and may transmit or receive data to and from an IAB-donor connected to at least one IAB-node via a backhaul link.

A UE may include a terminal, a mobile station (MS), a cellular phone, a smartphone, a computer, or a multimedia system capable of performing communication functions. In the disclosure, a “downlink” refers to a radio link via which a base station transmits a signal to a UE, and an “uplink” refers to a radio link via which a UE transmits a signal to a base station. Further, although the following description may be directed to an LTE or LTE-A system by way of example, embodiments of the disclosure may also be applied to other communication systems having similar technical backgrounds or channel types to the embodiments of the disclosure. Examples of other communication systems may include 5th generation mobile communication technologies (5G, new radio, NR) developed beyond LTE-A, and in the following description, the “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, may be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Wireless communication systems have been developed from an initial wireless communication system providing a voice-oriented service to a broadband wireless communication system providing a high-speed and high-quality packet data service, such as those according to communication standards including a high-speed packet access (HSPA) of 3GPP, long-term evolution (LTE) (or evolved universal terrestrial radio access (E-UTRA)), LTE-advanced (LTE-A), LTE-Pro, high rate packet data (HRPD) of 3GPP2, ultra-mobile broadband (UMB), and 802.16e of IEEE.

In an LTE system, which is a representative example of the broadband wireless communication system, a downlink (DL) adopts an orthogonal frequency division multiplexing (OFDM) scheme and an uplink (UL) adopts a single carrier frequency division multiple access (SC-FDMA) scheme. The uplink refers to a radio link via which a UE transmits data or a control signal to a base station (BS) (or eNode B), and the downlink refers to a radio link via which a base station transmits data or a control signal to a UE. In such a multi-access scheme, normally data or control information of each user may be distinguished by assigning and operating time-frequency resources, at which the data or control information of each user is to be transmitted, so as not to overlap each other, that is, to establish orthogonality.

A 5G communication system, that is, a future communication system after LTE, should be able to freely reflect various requirements of users, service providers, etc., so that a service that concurrently satisfies various requirements should be supported. Services considered for the 5G communication system includes an enhanced mobile broadband (eMBB) communication, massive machine type communication (mMTC), ultra-reliability low latency communication (URLLC), and the like.

The eMBB aims to provide a data transmission rate that is more improved than a data transmission rate supported by existing LTE, LTE-A or LTE-Pro. For example, in the 5G communication system, an eMBB should be able to provide a maximum data rate (peak data rate) of 20 Gbps in a downlink and a peak data rate of 10 Gbps in an uplink from the perspective of one base station. The 5G communication system needs to provide a peak data rate while concurrently providing an increased actual user perceived data rate of a UE. In order to satisfy these requirements, improvement of various transmission or reception technologies including a more advanced multi-antenna (multi-input multi-output (MIMO)) transmission technology is required. A signal may be transmitted using a maximum transmission bandwidth of 20 MHz in a 2 GHz band used by LTE, whereas, in the 5G communication system, a data transmission rate, which is required by the 5G communication system, may be satisfied by using a frequency bandwidth wider than 20 MHz in a frequency band of 3 to 6 GHz or a frequency band of 6 GHz or higher.

Meantime, the mMTC is being considered to support application services, such as Internet of things (IoT), in the 5G communication system. In order to efficiently provide the IoT, the mMTC may require support of a large-scale UE access in a cell, coverage enhancement of a UE, an improved battery time, cost reduction of a UE, and the like. The IoT is attached to multiple sensors and various devices to support communication functions, so that the IoT should be able to support a large number of UEs (e.g., 1,000,000 UEs/km2) within a cell. Due to the nature of a service, a UE that supports the mMTC is likely to be located in a shaded region, which cannot be covered by a cell, such as the basement of a building, and therefore a wider coverage may be required compared to other services provided by the 5G communication system. The UE that supports the mMTC may be required to be a low-cost UE, and since it is difficult to frequently replace a battery of the UE, a very long battery lifetime, such as 10 to 15 years, may be required.

Finally, the URLLC corresponds to a cellular-based wireless communication service used for a specific purpose (mission-critical). For example, services, etc. used for a remote control of a robot or machinery, industrial automation, an unmanned aerial vehicle, remote health care, an emergency alert, and the like may be considered. Therefore, communication provided by the URLLC should also provide very low latency and very high reliability. For example, a service that supports the URLLC should satisfy an air interface latency less than 0.5 milliseconds and has requirements of a packet error rate of 10-5 or less at the same time. Therefore, for the service that supports the URLLC, the 5G system may be required to provide a transmit time interval (TTI) smaller than other services, and at the same time, design matters for allocating a wide resource in a frequency band may be required to secure the reliability of the communication link.

Three services of 5G, which are the eMBB, the URLLC, and the mMTC, may be multiplexed and transmitted in one system. Different transmission or reception techniques and transmission or reception parameters may be used between services in order to satisfy different requirements of respective services. 5G is not limited to the three services described above.

For convenience of description below, some terms and names defined in the 3GPP standard (standards of 5G, NR, LTE, or similar systems) may be used. However, the disclosure is not limited by the terms and names, and may be equally applied to systems conforming to other standards. Terms used for identifying an access node, terms indicating network entities, terms indicating messages, terms indicating interfaces between network entities, terms indicating various identification information, etc. used in the following description are illustrated for convenience of description. Therefore, the disclosure is not limited to the terms used herein, and other terms referring to objects having equivalent technical meanings may be used.

There are several different cases of DC, including cases in which the MCG and the SCG use a different Radio Access Technology, RAT. For instance, the UE may be configured with an MCG using Long Term Evolution, LTE, known as 4G, and an SCG using New Radio, NR′ known as 5G. This disclosure in particular addresses DC cases for which one of the cell groups uses NR. The general term Multi RAT Dual Connectivity, MR-DC, is herein used to refer to these DC cases. This is meant to include the case of NR DC i.e. with both MCG and SCG using NR. 3GPP specification TS 37.340 provides a general description of this.

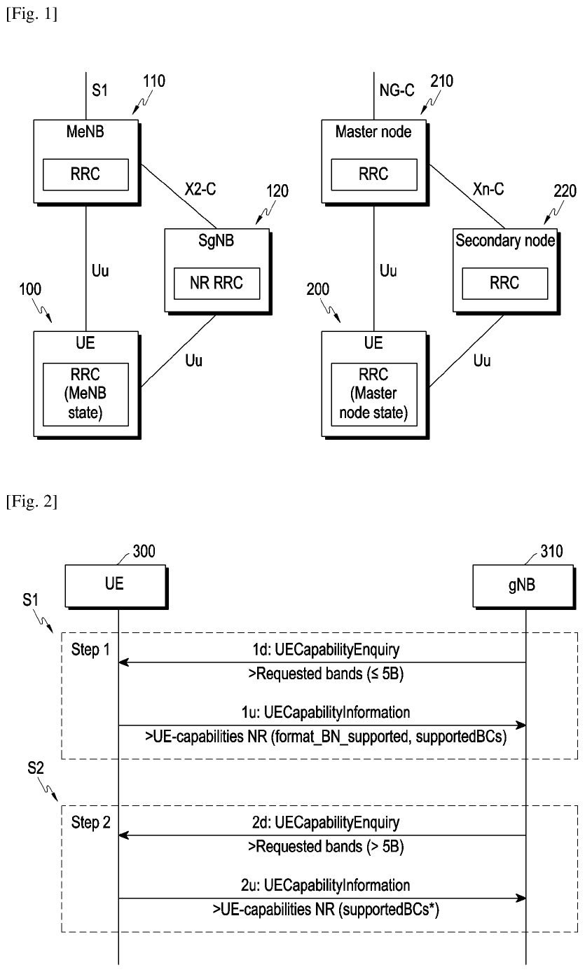

FIG. 1 shows a control plane architecture known in a wireless communication system.

Referring to FIG. 1, the control plane architecture for EN-DC (left) and MR-DC with a 5G core (right) is shown. In each case, it shows a UE 100, 200 connected to a Master eNB 110 or Master Node 210, as well as a Secondary gNB 120 or Secondary Node 220. The various interface names are also shown.

The UE signals its capabilities to the network. In case of MR-DC, with the MCG using LTE and the SCG using NR (referred to as EN-DC) or vice versa (i.e. the MCG using NR and the SCG using LTE, referred to as NE-DC), the UE signals its capabilities by 3 different parts:
a) LTE capabilities, that are used by the LTE eNB
b) NR capabilities, that are used by the NR gNB
c) MR-DC capabilities, that are used by both LTE eNB and NR gNB

As the signalling associated with UE capabilities may be quite large i.e. require a substantial amount of data, methods have been defined to reduce the size. One such option is that the UE omits band combinations that are fallbacks from another band combination that is included in the UE capabilities. A fallback BC is defined in 3GPP TS 38.306:

“Fallback band combination: A band combination that would result from another band combination by releasing at least one SCell or uplink configuration of SCell, or SCG. An intra-band non-contiguous band combination is not considered to be a fallback band combination of an intra-band contiguous band combination.”

One of the UE capabilities relevant for operation in MR-DC concerns the grouping of cells i.e. which cells part of the BC the UE may support in a particular cell group. For the case of NR DC, it has been agreed to introduce signalling similar to what is defined in LTE, although there are some differences:

A UE only supporting Release 15, R15, of the applicable standard, will not signal any cell group capabilities. It will only support synchronous DC, and for each supported BC, the UE supports the MCG comprising any cell using a band of the BC that is in Frequency Range 1, FR1, and the SCG comprising any cell using a band of the BC that is in Frequency Range 2, FR2.

A UE supporting Release 16, R16, of the applicable standard, may indicate the additional cell grouping options it supports for synchronous DC, as follows:
the UE may indicate it supports any grouping
the UE may signal a bitmap, similar to the one used in LTE, but with some differences:
a) A bit of the bitmap corresponds to a band rather than a band-entry, with a maximum of 5 bands
b) the UE may separately indicate which grouping it supports for MCG and SCG

An R16 UE that supports asynchronous DC may, for each BC, indicate whether it supports:
Cell groupings as defined for synchronous DC in R15 (MCG in FR1 and SCG in FR2) i.e. by absence of cell grouping signalling
The same cell grouping as for synchronous DC
Cell grouping as indicated by a bitmap, the same as for synchronous DC (see above)

The solution adopted by RAN2 involves changes that are covered by the following Change Requests, CRs:
R2-2102210: 38.331 CR #2472 Introduction of Cell Grouping UE capability for NR-DC
R2-2102211: 38.306 CR #0540 Introduction of Cell Grouping UE capability for NR-DC

The main change introduced by CR #2472 concerns an extension of CA-ParametersNRDC, as shown in the following Table 1. The CA-ParametersNRDC contains dual connectivity related capabilities that am defined per band combination.

TABLE 1

| CA-ParametersNRDC-v16xy ::= SEQUENCE { | |
|---|---|
| cellGroupingSync-r16 | CHOICE { |
| anyGrouping | NULL, |
| twoBands-r16 | BIT STRING (SIZE(2)), |
| threeBands-r16 | BIT STRING (SIZE(6)), |
| fourBands-r16 | BIT STRING (SIZE(14)), |
| fiveBands-r16 | BIT STRING (SIZE(30)) |
| } | OPTIONAL, |
| cellGroupingAsync-r16 | CHOICE { |
| sameAsSync | NULL, |
| twoBands-r16 | BIT STRING (SIZE(2)), |
| threeBands-r16 | BIT STRING (SIZE(6)), |
| fourBands-r16 | BIT STRING (SIZE(14)), |
| fiveBands-r16 | BIT STRING (SIZE(30)) |
| } | OPTIONAL |

}

The Table 1 shows a modified ASN.1 extract related to an embodiment of the disclosure, and the modified ASN.1 extract introduces cell grouping signalling and shows the changes required in order to implement an embodiment of the disclosure.

The main change introduced by CR #0540 concerns specification of the use of the bit strings as shown in in the following Table 2.

TABLE 2

| | Nr of Frequency Bands: | | | |
|---|---|---|---|---|
| | 5 | 4 | 3 | 2 |
| | Length of Bit-String: | | | |
| | 30 | 14 | 6 | 2 |
| Bit String Position | Cell grouping option (0 = MCG, 1 = SCG) | | | |
| 1 | 00001 | 0001 | 001 | 01 |
| 2 | 00010 | 0010 | 010 | 10 |
| 3 | 00011 | 0011 | 011 | |
| 4 | 00100 | 0100 | 100 | |
| 5 | 00101 | 0101 | 101 | |
| 6 | 00110 | 0110 | 110 | |
| 7 | 00111 | 0111 | | |
| 8 | 01000 | 1000 | | |
| 9 | 01001 | 1001 | | |
| 10 | 01010 | 1010 | | |
| 11 | 01011 | 1011 | | |
| 12 | 01100 | 1100 | | |
| 13 | 01101 | 1101 | | |
| 14 | 01110 | 1110 | | |
| 15 | 01111 | | | |
| 16 | 10000 | | | |
| 17 | 10001 | | | |
| 18 | 10010 | | | |
| 19 | 10011 | | | |
| 20 | 10100 | | | |
| 21 | 10101 | | | |
| 22 | 10110 | | | |
| 23 | 10111 | | | |
| 24 | 11000 | | | |
| 25 | 11001 | | | |
| 26 | 11010 | | | |
| 27 | 11011 | | | |
| 28 | 11100 | | | |
| 29 | 11101 | | | |
| 30 | 11110 | | | |

The Table 2 shows an extract for the referenced CR which relates to cell grouping and bit string usage. Note that the mapping of serving cells to cell groups (i.e. MCG or SCG), as indicated by cellGroupingSync-r16 and cellGroupingAsync-r16, is shown in this table 2.

A cell grouping option is represented by a number of bits, where the left-most bit corresponds to the frequency band listed first in the band combination, etc.

Referring to the Table 2, value 0 indicates that the carriers of the corresponding frequency band are mapped to MCG, while value 1 indicates that the carriers of the corresponding frequency band are mapped to SCG.

The leading/leftmost bit of cellGroupingSync-r16 and cellGroupingAsync-r16 respectively corresponds to the Bit String Position 1.

Before the above described solution was adopted, there was some debate, as the cell grouping signalling could result in some appreciable additional signalling overhead, in particular for BCs involving a larger number of cells. These concerns were at least partly addressed by restricting implementation such that all cells in the same band are part of same cell group, so that a bit of the bitmap may represent a band rather than a band entry. Nevertheless, suggestions were made of other options with less granularity (e.g. re-using the PUCCH cell grouping) that would particularly be needed for BCs involving a large number of bands e.g. beyond 5 bands (referred to as “>5B BCs” in the following).

Given the ongoing discussions, it may be expected that other cell grouping signalling options may be introduced in a future release network, RN, of the specification. Herein, this will be referred to as the RN format.

So far, only NR DC BCs comprising of at most 4 bands are defined. However, further BCs involving a higher number of bands may be introduced in the future release network. Moreover, these may be introduced in a release independent manner.

It is currently not clear whether in such case the UE capability reporting operations will be modified or not. It seems preferable if the UE capability reporting procedures introduced in R16 are defined, considering that BCs involving more than 5 bands will be introduced in the future release network.

The cell group signalling introduced in R16 may be used for the above mentioned “>5B BCs”, but the grouping options that the UE may indicate are limited (as the bitmap format does not support the “>5B BCs”):
For synchronous DC, the UE may indicate that it supports
a) R15 grouping (i.e. by absence of per BC signalling) and
b) Any grouping
For asynchronous DC, the UE may similarly indicate it supports
a) R15 grouping (i.e. by absence of per BC signalling) and
b) Any grouping (i.e. by indicating same as synchronous DC, while indicating support of any grouping for synchronous DC)

It is currently however unclear whether R16 UE is allowed to indicate it supports the “>5B BCs” using the above options.

The following relates to capability reporting by R16 UE for the “>5B BCs”. As indicated previously, it is not entirely clear what cell grouping capabilities a R16 UE would report when the network (e.g. a base station) requests the “>5B BCs”. A first option may be that network avoids this as follows.

In a first option, the network ensures that only UEs supporting the new RN format will report the “>5B BCs” e.g. by setting a band filter including at most 5 bands.

The network option according to the previous implies that network may only request a UE to report the “>5B BCs” when it knows that the UE supports the new format (RN format). In other words, a network interested to have UE capabilities for the “>5B BCs” will have to use the following 2 steps:
1) A first UE capability enquiry, with limited number of bands listed, merely to find out whether the UE supports the new format
2) A second UE capability enquiry, in which network may set the band list to include the “>5B BCs” that it would like to know about

FIG. 2 shows a 2 step capability enquiry according to an embodiment of the disclosure.

Referring to FIG. 2, FIG. 2 shows message exchanges between UE 300 and gNB 310. The two messages referred to above are designated S1 and S2, respectively. In S1, gNB 310 transmits, to UE 300, UE Capability Enquiry including information about Request bands which is equal to or less than 5BCs (201), and gNB 310 receives, from UE 300, UE Capability information including UE capabilities NR (e.g. format BN supported, supported BCs, etc.)(202). In S2, gNB 310 transmits, to UE 300, UE Capability Enquiry including information about Request bands which is greater than 5BCs (203), and gNB 310 receives, from UE 300, UE Capability information including UE capabilities NR (e.g. supported BCs, etc.)(204).

Avoiding such a 2-step approach seems possible, but it requires that UE behaviour is defined as by the following second option.

The second option specifies UE capability reporting for a UE that supports:
The cell grouping format as introduced in R16, referred to as R16 format, but not any further format as may be introduced in a future release RN of the specification (referred to as RN format) and
Band combinations involving more than 5 bands (i.e. referred to as >5B BCs)

There are options for the UE capability reporting by a UE according to the second option when the network includes in the UE capability enquiry a band list including more than 5 bands:
a) the UE does not include any >5B BCs
b) the UE only includes >5B BCs for which it supports R15 grouping (MCG in FR1 and SCG in FR2)
c) the UE only includes >5B BCs for which cell grouping may be indicated by R16 UE capability signalling i.e. both
1. BCs for which it supports R15 grouping (MCG in FR1 and SCG in FR2)
2. BCs for which UE supports any cell grouping

The above may be reflected in the applicable standards in different ways, including the following options:
i) Adding statements in field description
ii) Adding procedural specification

An example of option i) for case c, immediately above, is shown the below Table 3.

TABLE 3
CA-ParametersNRDC field descriptions

ca-ParametersNR-forDC (with and without suffix)
If this field is present for a band combination, it reports the UE
capabilities when NR-DC is configured with the band combination.
If no version of this field (i.e., with and without suffix)
is present for a band combination, the ca-ParametersNR field
versions (with and without suffix) in BandCombination are applicable
to the UE configured with NR-DC for the band combination. UEs may
include BCs comprising more than 5 bands for which it either supports
all MCG cells in FR1 and all SCG cells in FR2 or any cell grouping.
featureSetCombinationDC
If this field is present for a band combination, it reports
the feature set combination supported for the band combination when
NR-DC is configured. If this field is absent for a band combination, the
featureSetCombination in BandCombination (without suffix) is applicable
to the UE configured with NR-DC for the band combination.

The statement above “UEs may include BCs comprising more than 5 bands for which it either supports all MCG cells in FR1 and all SCG cells in FR2 or any cell grouping” differentiates this from the known prior art definition.

The following relates to capability filtering for reporting by R16 UE. Even if the UE applies the R16 format for the “≤5B BCs”, this will introduce possibly significant additional signalling. Some of the cell grouping information may however not be relevant for network. It is therefore beneficial to introduce some form of network control.

An embodiment introduces means for the network to control the cell grouping information that the UE includes in the UE capabilities.

In this regard, there are various options for the network to control which cell grouping information the UE shall include, comprising the following:
a) a field indicating whether the UE shall include cell grouping for asynchronous DC
b) a field indicating whether the UE is allowed to include cell grouping for asynchronous DC other than ‘R15 grouping’ and ‘any grouping’
c) a field indicating whether the UE shall include cell grouping for synchronous DC
d) a field indicating whether the UE is allowed to include cell grouping for synchronous DC other than ‘R15 grouping’ and ‘any grouping’

The introduction of new filter option(s) as above involves an extension of the UECapabilityEnquiry message. There are 2 different filters that might be used:
a) UE-CapabilityRequestFilterCommon
b) UE-CapabilityRequestFilterNR

The filter affects for which NR DC BCs the UE provides the cell grouping information. At first glance, it does not seem to affect which BCs the UE actually includes in the list of supported BCs. However, it may be that the grouping filter will actually affect which supported BCs a UE reports e.g. because cell grouping options are different for a fallback BC, meaning that the UE may report a fallback BC when cell grouping info is requested. In any event, the filter may be added to either of the filters listed immediately above.

The following Table 4 shows an example of how to reflect the aforementioned embodiment by extension of a common UE capability filter. The underlined portion indicates the adaptation. Table 4 refers to an ASN.1 extract related to a UE capability filter related to an embodiment of the disclosure.

TABLE 4

| UE-CapabilityRequestFilterCommon ::= | SEQUENCE { | |
|---|---|---|
| mrdc-Request | SEQUENCE { | |
| omitEN-DC | ENUMERATED {true} | OPTIONAL, -- Need N |

```
-- Irrelevant parts omitted
  ...,
  [[
```

| | |
|---|---|
| codebookTypeRequest-r16 | SEQUENCE { |

-- Irrelevant parts omitted

| type1-SinglePanel-r16 | ENUMERATED {true} | OPTIONAL, |
|---|---|---|
| } | | OPTIONAL, -- Need N |
| uplinkTxSwitchRequest-r16 | ENUMERATED {true} | OPTIONAL -- Need N |

[[

| | | |
|---|---|---|
| dc-CellGroupingRequestAsync-r16 | ENUMERATED {true} | OPTIONAL -- Need N |

```
  ]],
  ]]
}
```

The following relates to further enhancements regarding capability reporting by UE supporting RN format. In an embodiment, UE capability reporting is specified for a UE that supports the cell grouping format as introduced in RN, referred to as RN format. The UE will also support formats introduced in earlier releases).

There may be different options regarding how UE should use the new format.

In a first embodiment, options are provided regarding for which BCs a UE applies the RN format:
1) Option 1: “>5B BCs”
2) Option 2: Any BC
3) Option 3: Specific BCs, in accordance with network control

Options 1 and 2, above, may be reflected in standard specifications in a manner similar to what is shown in the table related to CA-ParametersNRDC field descriptions, shown previously.

As described previously, the R16 specification may allow a UE not supporting RN format to include the “>5B BCs” although such a UE may only indicate limited options. The RN format supports indication of additional grouping options, but this comes at the cost of additional signalling overhead. Hence, network control would be appropriate.

A further question is whether UE should use the new format for the “≤5B BCs” i.e. instead of the R16 format. This may be desirable to reduce signalling overhead but comes at the cost of reduced granularity. Moreover, if not all RAN nodes support the RN format, this option may require legacy nodes to again retrieve the UE capabilities. Hence, separate network control seems desirable.

A further option may be that the network provides further details regarding for which BCs the UE shall apply the RN format. For instance, it may be used for particular bands, for BCs involving more than N bands.

In a further embodiment, options for the network to control which cell grouping format the UE shall apply include the following:
a) Field indicating that UE is allowed/requested to use RN format
b) Field indicating that UE is allowed/requested to use RN format for “>5B BCs”
c) Field indicating that UE is allowed/requested to use RN format for “≤5B BCs”
d) Field indicating that UE is allowed/requested to use RN format for specific BCs i.e. indicating some particular further detailed criteria the BC should meet in order to use RN format

Options for more detailed network control of which cell grouping format that the UE shall apply include the following:
a) BC comprises specific bands as indicated by network
b) BC comprises at least a certain number of bands
c) BC comprises bands with specific properties e.g. part of a particular frequency range

With regard to how to reflect the aforementioned in applicable standards, this may either be done by the NR or the common filter and if the latter option is adopted, it may be done in a similar manner as shown by the example in the Table 4.

Embodiments of the disclosure provide advantages over the cited art. For instance, Capability reporting by R16 UE for the “5B BCs” has the benefit of clarifying UE operations regarding cell grouping capabilities, facilitating extensions in the future while avoiding any interoperability problems. Capability filtering for reporting by R16 UE has the benefit of reducing signalling overhead by avoiding transfer of capability info not relevant for network at the cost of some limited additional complexity. Enhancements regarding capability reporting by a UE supporting RN format has the benefit of introducing UE operations regarding use of different formats for cell grouping capabilities, with network control in order to avoid any interoperability problems.

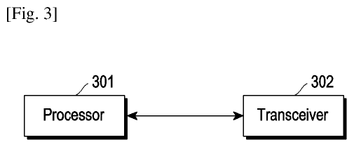

FIG. 3 shows a block diagram of a network entity performing operations according to an embodiment of the disclosure. The network entity may be one of the UE and the gNB (that is, base station).

Referring to FIG. 3, the network entity may include a processor 301 and a transceiver 302. In the wireless communication system described above in connection with FIGS. 1 and 2, according to the disclosure, the network entity may be operated in the manners described above in connection with FIGS. 1 to 5. However, the components of the network entity are not limited thereto. According to an embodiment, the network entity may include more components than those described above or, the network entity may include fewer components. According to an embodiment, the processor 301 and the transceiver 302 may be implemented in the form of one or more chips.

According to an embodiment, the transceiver 302 may include a transmitter and a receiver, or further include a communication interface communicating with other network entity via wired or wireless communication. The processor 301 may control operations to allow the network entity to operate according to one or a combination of the above-described embodiments.

It should be noted that the above-described configuration views, example views of control/data signal transmission methods, example views of operational procedures, and configuration views are not intended as limiting the scope of the disclosure. In other words, all the components, entities, or operational steps described in connection with the embodiments should not be construed as essential components to practice the disclosure, and the disclosure may be rather implemented with only some of the components without departing from the gist of the disclosure. The embodiments may be practiced in combination, as necessary. For example, some of the methods proposed herein may be combined to operate the network entity and the terminal.

The above-described operations of the base station or terminal may be realized by equipping a memory device retaining their corresponding codes in the base station device or any component of the UE. That is, the processor in the eNB or terminal may execute the above-described operations by reading and executing the program codes stored in the memory device by a processor or central processing unit (CPU).

As described herein, various components or modules in the entity, the base station or UE may be operated using a hardware circuit, e.g., a complementary metal oxide semi-conductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments via an external port. A separate storage device over the communication network may be connected to the device that performs embodiments.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments have been described above, various changes may be made thereto without departing from the scope of the disclosure. Thus, the scope of the disclosure should not be limited to the above-described embodiments, and should rather be defined by the following claims and equivalents thereof. In other words, it is apparent to one of ordinary skill in the art that various changes may be made thereto without departing from the scope of the disclosure. Further, the embodiments may be practiced in combination. For example, some of the methods proposed herein may be combined to operate the base station and the terminal. Although the embodiments are proposed in association with 5G and NR systems, various modifications thereto may apply to other various systems, such as LTE, LTE-advanced (LTE-A), LTE-A-Pro systems.

While the disclosure has been shown and described with reference to various embodiments thereof, it will be understood by those skilled in the art that various changes in form and details may be made therein without departing from the spirit and scope of the disclosure as defined by the appended claims and their equivalents.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A method of managing capability reporting by a user equipment (UE) in a wireless communication system configured for dual connectivity (DC), the method comprising:
receiving, from a base station, a first capability enquiry comprising information on a first set of bands;
transmitting, to the base station, a first reply including information indicating that the UE supports more than a predefined number of bands, in case that the UE supports more than the predefined number of bands;
receiving, from the base station, a second capability enquiry comprising information on a second set of bands more than the predefined number of bands; and
transmitting, to the base station, a second reply including UE capability information associated with the second set of bands.

2. The method of claim 1, wherein at least one of the first capability enquiry and the second capability enquiry includes at least one of:
information indicating whether the UE shall include cell grouping for asynchronous DC, information indicating whether the UE is allowed to include cell grouping for the asynchronous DC other than ‘R15 grouping’ and ‘any grouping’,
information indicating whether the UE shall include cell grouping for synchronous DC, and
information indicating whether the UE is allowed to include cell grouping for synchronous DC other than the ‘R15 grouping’ and the ‘any grouping’.

3. The method of claim 1, wherein the second UE capability enquiry includes a band list comprising more than the predefined number of band, and
wherein the second reply uses one of the following UE reply messages:
a UE reply message not including any band combinations (BCs) with more than the predefined number of bands;
a UE reply message only including BCs with more than the predefined number of bands; and
a UE reply message only including BCs with more than the predefined number of bands, for which cell grouping may be indicated by R16 UE capability signalling, including BCs for which the supports R15 grouping (MCG in FR1 and SCG in FR2) and BCs for which the UE supports any cell grouping.

4. The method of claim 1, wherein the UE is arranged to report the UE capability information in a specific format, supporting cell grouping, whereby the UE reports BCs using the first format for one of:
BCs with more than the predefined number of bands,
any BC, and
specific BCs, in accordance with network control.

5. The method of claim 1, wherein at least one of the first capability enquiry and the second capability enquiry includes at least one of:
information indicating that the UE is allowed or requested to use a specific format,
information indicating that the UE is allowed or requested to use a specific format for BCs having more than a predefined number of bands,
information indicating that the UE is allowed or requested to use a specific format for BCs having the predefined number of bands or less, and
information indicating that the UE is allowed or requested to use a specific format for specific BCs, including an indication of a particular criterion that the BC meets in order to use the specific format.

6. The method of claim 5, wherein the particular criterion includes one or more of:
a criterion that the BC comprises specific bands as indicated by the base station;
a criterion that the BC comprises at least a certain number of bands; and
a criterion that the BC comprises bands with specific properties, such as being a part of a particular frequency range.

7. A user equipment (UE) in a wireless communication system configured for dual connectivity (DC), the UE comprising:
a transceiver; and
a processor configured to:
receive, via the transceiver the from a base station, a first capability enquiry comprising information on a first set of bands,
transmit, to the base station via the transceiver, a first reply including information indicating that the UE supports more than a predefined number of bands, in case that the UE supports more than the predefined number of bands,
receive, via the transceiver from the base station, a second capability enquiry comprising information on a second set of bands more than the predefined number of bands, and
transmit, to the base station via the transceiver, a second reply including UE capability information associated with the second set of bands.

8. (canceled)

9. A method of managing capability reporting by a base station in a wireless communication system configured for dual connectivity (DC), the method comprising:
transmitting, to a user equipment (UE), a first capability enquiry comprising information on a first set of bands;
receiving, from the UE, a first reply including information indicating that the UE supports more than a predefined number of bands, in response to transmission of the first capability enquiry;
transmitting, to the UE, a second capability enquiry comprising information on a second set of bands more than the predefined number of bands; and
receiving, from the UE, a second reply including UE capability information associated with the second set of bands.

10. The method of claim 9, wherein at least one of the first capability enquiry and the second capability enquiry includes at least one of:
information indicating whether the UE shall include cell grouping for asynchronous DC;
information indicating whether the UE is allowed to include cell grouping for the asynchronous DC other than ‘R15 grouping’ and ‘any grouping’;
information indicating whether the UE shall include cell grouping for synchronous DC; and
information indicating whether the UE is allowed to include cell grouping for synchronous DC other than ‘R15 grouping’ and ‘any grouping’.

11. The method of claim 9, wherein the second UE capability enquiry includes a band list comprising more than the predefined number of band, and
wherein the second reply uses one of the following UE reply messages:
a UE reply message not including any band combinations (BCs) with more than the predefined number of bands,
a UE reply message only including BCs with more than the predefined number of bands; and
a UE reply message only including BCs with more than the predefined number of bands, for which cell grouping may be indicated by R16 UE capability signalling, including BCs for which the supports R15 grouping (MCG in FR1 and SCG in FR2) and BCs for which the UE supports any cell grouping.

12. The method of claim 9, wherein the UE is arranged to report the UE capability information in a specific format, supporting cell grouping, whereby the UE reports BCs using the first format for one of:
BCs with more than the predefined number of bands,
any BC, and
specific BCs, in accordance with network control.

13. The method of claim 9, wherein at least one of the first capability enquiry and the second capability enquiry includes at least one of:
information indicating that the UE is allowed or requested to use a specific format, information indicating that the UE is allowed or requested to use a specific format for BCs having more than a predefined number of bands,
information indicating that the UE is allowed or requested to use a specific format for BCs having the predefined number of bands or less, and
information indicating that the UE is allowed or requested to use a specific format for specific BCs, including an indication of a particular criterion that the BC meets in order to use the specific format,
wherein the particular criterion includes one or more of:
a criterion that the BC comprises specific bands as indicated by the base station;
a criterion that the BC comprises at least a certain number of bands; and
a criterion that the BC comprises bands with specific properties, such as being a part of a particular frequency range.

14. A base station in a wireless communication system configured for dual connectivity (DC), the base station comprising:
a transceiver; and
a processor configured to:
transmit, to a user equipment (UE), a first capability enquiry comprising information on a first set of bands,
receive, from the UE, a first reply including information indicating that the UE supports more than a predefined number of bands, in response to transmission of the first capability enquiry,
transmit, to the UE, a second capability enquiry comprising information on a second set of bands more than the predefined number of bands, and
receive, from the UE, a second reply including UE capability information associated with the second set of bands.

15. (canceled)
